(19) United States
(12) Patent Application Publication
(10) Pub. No.: US 2013/0284645 A1
(43) Pub. Date: Oct. 31, 2013

(54) SEPARATION APPARATUS

(71) Applicants: David Francis Porteus, Reedy Creek (AU); Paul Frederick Davis, Camberwell (AU); David John Williams, Nulkaba (AU)

(72) Inventors: David Francis Porteus, Reedy Creek (AU); Paul Frederick Davis, Camberwell (AU); David John Williams, Nulkaba (AU)

(73) Assignee: Australian Fine Coal Technology Pty Ltd., North Sydney (AU)

(21) Appl. No.: 13/698,061

(22) PCT Filed: Dec. 6, 2011
(86) PCT No.: PCT/AU2011/001583

§ 371 Date: Nov. 15, 2012

(30) Foreign Application Priority Data
Dec. 6, 2010 (AU) 2010905352

(51) Int. Cl. B03B 5/48

(52) U.S. Cl. CPC B03B 5/48
USPC 209/272

(57) ABSTRACT

A separation conveyor (10) for separating a mass or slurry of different sized particles is provided. The separation conveyor includes a filter belt (12) including a feed side for receiving the mass or slurry and a filtrate side. The separation conveyor further includes a conveyor assembly (16) for conveying the filter belt, an overhead spray array (28) for spraying fluid downwards onto the slurry as it travels on the filter belt, and a lower spray array (30) for spraying fluid upwards against an underside of the belt. The upper and lower spray arrays are arranged in combination to assist in promoting separation of oversized particles on the feed side of the belt and undersized particles on the filtrate side of the belt.

### FIELD OF THE INVENTION

The invention relates generally to apparatus and methods of separating out from fluid slurries of differently sized particulate matter over- and under-sized particulate fractions. In one particular aspect, the invention relates to separating out fine coal particles from ultra-fine coal particles.

### BACKGROUND OF THE INVENTION

In materials processing the separation of fine particles by their size tends to be expensive and/or inaccurate in certain applications where the undersize fraction is the contaminant and the oversized fraction the desired product. This expense/inefficiency has resulted in additional inefficiencies in downstream processes. In order to reduce such inefficiencies, separation processes are often designed to separate the majority of the undersized contaminant, but in doing so also separate (and waste) part of the oversized desired product.

In applications such as the briquetting of coal fines from tailings dams, ultrafines (particles having a size of around less than 40 μm) cannot effectively be used in the briquetting process (unless they are further beneficiated, which is generally too expensive a process to be viable). In separating waste material (such as clay) of size less than 40 μm from the coal particles, however, valuable coal particles of size greater than 50 μm are also often separated and lost, in particular when conventional vibrating screens are used having typical mesh sizes of 300 μm or more.

Various types of filter or separator arrangements are used to separate out the coal ultrafines from the coal fines before briquetting takes place. A coal slurry is typically formed, which is then fed over a filter bed configured with a mesh size through which ultra-fines can pass.

One problem which has been encountered is that of clogging, in which near-sized particles tend to clog the apertures through which the ultrafine particles are arranged to pass. A further problem which may arise is that of stratification or settling, in which larger heavier particles settle on the filter bed below the ultra-fines and affect the passage of ultra-fine particles through the filter apertures. In addition, in a high speed and high volume briquetting operation, it is desirable that throughput of particles is maximised or at least significantly increased.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In one aspect, the invention provides a separation conveyor for separating a mass or slurry of different sized particles, the separation conveyor including: a filter belt including a feed side for receiving the mass or slurry and a filtrate side; a conveyor assembly for conveying the filter belt; an overhead spray array for spraying fluid downwards onto the slurry as it travels on the filter belt; a lower spray array for spraying fluid upwards against an underside of the filter belt, wherein the upper and lower spray arrays are arranged in combination to assist in promoting separation of oversized particles on the feed side of the belt and undersized particles on the filtrate side of the belt.

The overhead spray array may include an array of overhead spray bars, and the lower spray array includes an array of lower spray bars, wherein the upper and lower spray bars are offset relative to one another.

The conveyor assembly may include a plurality of rollers around which the filter belt travels, the upper and lower spray arrays being arranged between the rollers

The lower spray array may include at least one sidewardly or downwardly directed spray bar directed against an undersurface of the filter belt.

In another aspect the invention provides a method of separating a mass or slurry of different sized particles into undersize and oversize particles including: feeding the slurry onto a filter belt having an upper feed side and a lower filtrate side; conveying the slurry along the filter belt; directing sprays downwards onto the slurry via an overhead spray array; directing sprays upwards against an underside of the filter belt via a lower spray array to unclog the filter belt, and collecting the filtrate including the undersize particles and collecting the oversize particles at a downstream end of the filter belt.

### BRIEF DESCRIPTION OF THE DRAWINGS

FIG. 1 shows a side view of one embodiment of a separation apparatus of the invention;

FIG. 2 shows a top plan view of the separation apparatus of FIG. 1;

FIG. 3 shows a front view of the separation apparatus;

FIG. 4 is a schematic side view illustrating an alternative configuration of the separation apparatus; and

FIG. 5 shows a side view of another embodiment of the separation apparatus.

### DETAILED DESCRIPTION OF THE EMBODIMENTS

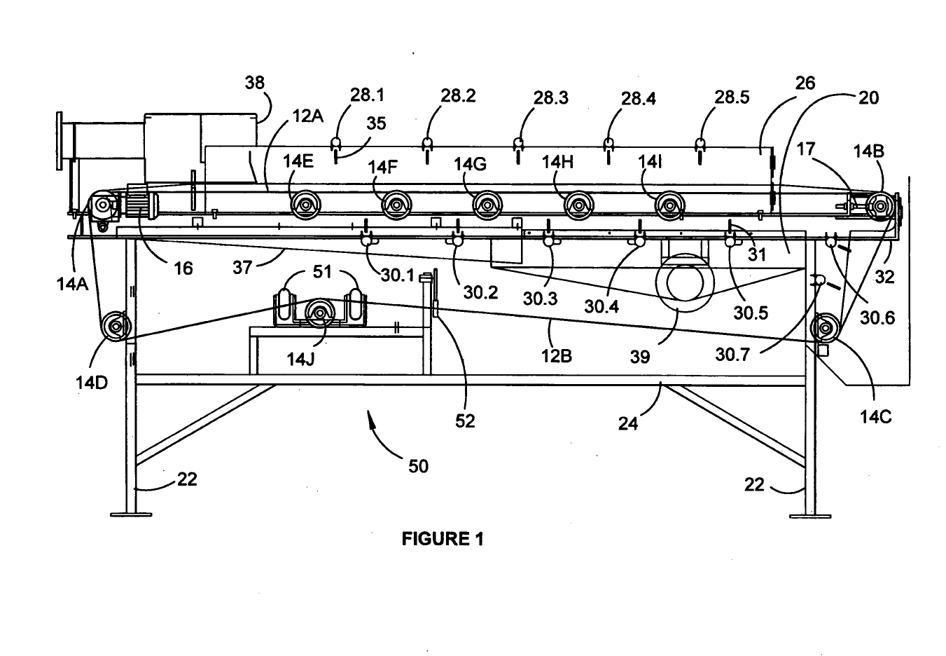

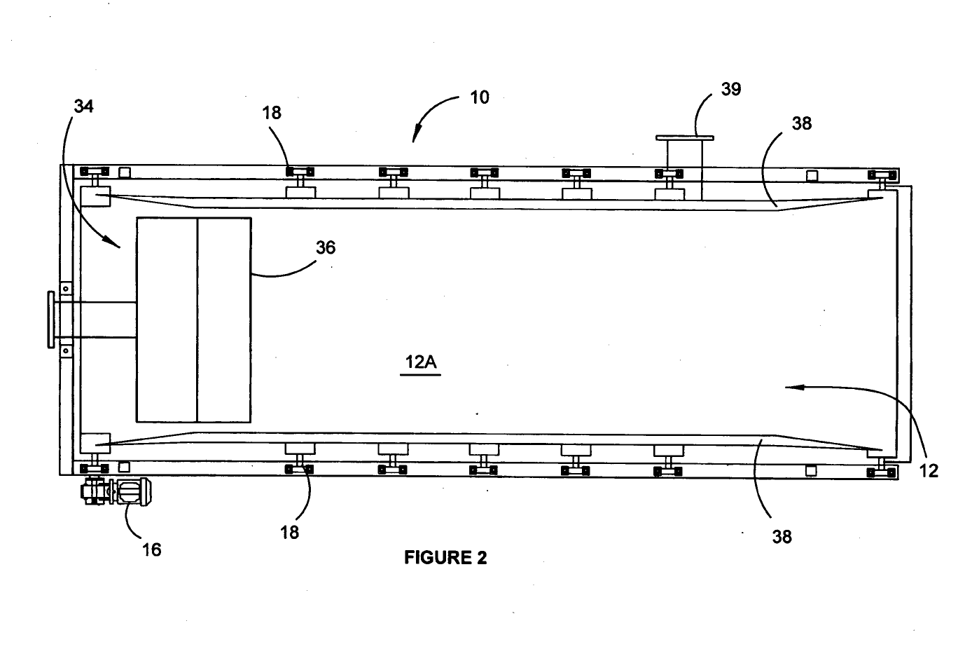

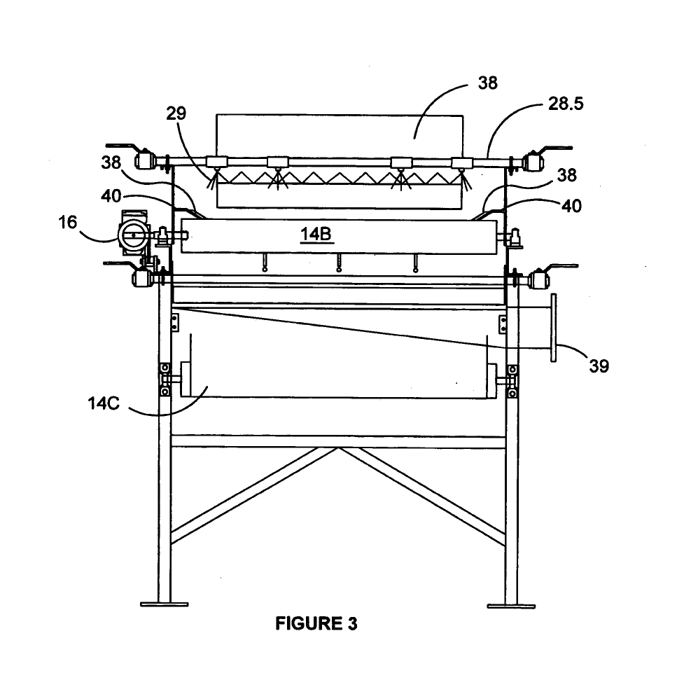

Preferred embodiments of the separation or belt filter apparatus 10 are illustrated in FIGS. 1-5.

The apparatus 10 includes a filter medium in the form of a continuous conveyer belt 12. The conveyor belt 12 may be manufactured from a variety of materials including, for example, woven steel mesh (e.g. stainless steel) or durable synthetic fibres (such as polyester, nylon or polyamide). Composite conveyor belts may also be used, for example a fine stainless steel bonded to an open weave polyester or nylon belt. The conveyor belt will typically be formed from a material having an aperture size of between approximately 50 μm to 150 μm. It will be appreciated that different sized apertures may be used depending on the material being separated and the desired sizes of the undersized and oversized fractions. These may range for example from materials with aperture sizes of 40 μm to 250 μm or more, but are preferably in the 40-50 μm to 150 μm range. Apertures of approximately 100 μm will be appropriate for certain applications. Parts of the belt including the side margins may be impregnated with a polymer such as polyurethane to increase wearability. Typically, a narrow polyurethane strip, having in the particular embodiment a width of 25 mm, is applied to each side margin to reduce fraying and increase wearability. The belt may be made of a woven stainless steel. Alternatively, the belt may be a woven polyester. For example, the belt may be a woven polyester with an aperture size around 125 micron. This may obtained by weaving a belt from a 0.125 mm polyester fibre using a schedule 2 weave with a secondary fibre of 1 mm diameter woven through the material using a schedule 2 weave to provide additional strength. There are around 50-60 threads per cm of the 0.125 mm fibres per cm to provide the desired aperture size. The material used for the belt is preferably not hydrophobic.

The conveyor belt 12 is guided on top and bottom end rollers 14A, 14B, 14C and 14D respectively. Equispaced support rollers 14E, 14F, 14G, 14H and 14I are positioned in a uniplanar configuration to support an upper reach 12A of the conveyer belt 12. In this embodiment roller 14A is also a drive roller which is coupled to a variable speed motor 16 to drive the conveyor belt 12. Roller 14B is mounted to the frame 20 via a tensioning arrangement 17 which maintains correct tension in the conveyor belt 12. The tensioning arrangement 17 includes a threaded bar which passes through a complementarily threaded aperture. The bar can be screwed in/out to adjust the position of the roller 14B and, consequently, the tension in the conveyor belt 12. The rollers 14A to 141 are journalled on bearings 18 which are in turn mounted on a support frame 20 having legs 22 and a lower frame portion 24.

In one embodiment the heights of the legs 22 are independently adjustable (e.g. telescopically) to allow the angle of the conveyor belt 12 to be altered. By extending the legs 22 at the discharge end of the conveyor belt 12 (i.e. the end proximate roller 14B), the belt 22 can be inclined in the direction of travel thereby increasing the retention time of the slurry on the belt 12. The degree of inclination of the belt can be adjusted to effectively stop (or reduce) excess water from flowing off either end of the belt 12. This is typically achieved by providing the belt 12 with a greater inclination when it is running at a higher/faster speed.

The apparatus 10 also includes a tracking assembly 50 mounted on the support frame 20, the tracking assembly 50 assisting in keeping the conveyor belt 12 centred on the rollers. The tracking assembly 50 includes a pivotally mounted tracking roller 14J which bears up against an undersurface of the lower reach 12B of the conveyor belt 12. The tracking assembly 50 further includes a tracking sensor 52 which tracks the alignment of the conveyor belt 12 and two air bellows 51. Based on information from the tracking sensor 52, the two air bellows are operated to move the tracking roller 14J and vary the tension of the conveyor belt 12 from side-to-side, thereby maintaining a central alignment of the conveyor belt 12.

An upper frame portion 26 carries five overhead spray bars 28.1 to 28.5 extending transversely relative to the direction of the conveyor belt 12. In one arrangement the spray bars are equi-spaced. The spray bars 28.1-28.5 are formed with a plurality of lowermost apertures configured to direct jets of water 35 vertically down onto the slurry being carried on the upper reach 12A of the conveyer belt 12. The lowermost apertures will generally be along the length of the relevant spray bar extending over the conveyor belt 12. The number of lowermost apertures per spray bar will depend on the width of the belt 12, however there will typically be up to 6 lowermost apertures per spray bar. The upper frame 26 supports the sprays such that their nozzles (apertures) are approximately 200 mm from the upper reach 12A of the conveyor belt 12. The spray bars 28.1-28.5 span the entire width of the conveyor belt 12 and the jets are configured so that they fan out to provide complete coverage across the width of the conveyor belt 12, with the end sprays being angled inwardly to keep the material on the belt. It can clearly be seen in FIG. 1 how the spray bars are positioned so that they are offset from the rollers 14E-14I.

Five lower spray bars 30.1-30.5 are mounted on an intermediate frame portion 32 of the frame beneath the upper reach 12 of the conveyer belt. The spray bars 30.1-30.5 are formed with uppermost apertures which direct a plurality of jets of water 31, for example two to five jets of water, 31 upwardly against the under-surface of the upper reach 12A of the conveyer belt 12 across its entire width. The intermediate frame portion 32 supports the lower sprays such that their nozzles are approximately 200 mm from the under surface of the upper reach 12A of the conveyor belt 12. The lower spray bars 30.1-30.5 are offset from both the upper spray bars and the rollers 14E-14I so that there is minimal or at least reduced interference between the upper and lower sprays and the rollers in operation, with each of the upper spray bars, lower spray bars and rollers offset from one another.

The upper reach 12 of the conveyor belt will typically extend (and carry the slurry being filtered) a distance beyond the last spray bar in order to allow for further draining. While this distance may be varied according to the characteristics of the slurry, extending the upper reach 12 around one to two meters beyond the last spray bar will typically be suitable.

In one embodiment the upper and lower spray bars are plumbed so as to allow the bars to be operated independently of one another. Accordingly, if a filtering operation does not require use of all spray bars some spray bars can be shut off, thereby minimising or at least reducing water consumption. The characteristics of the solid matter in the various slurries being separated will vary from site to site. Shutting spray bars off may be appropriate in instances where there is less fine material to be removed and/or there is a low concentration of solids in the feed slurry.

In operation, a coal slurry containing a mixture of differently sized coal particles is introduced onto the feed end 34 of the conveyer belt through a feed box or hopper 38. In one embodiment, the feed box 38 distributes the slurry substantially over the entire width of the conveyor belt 12, and supplies the slurry at a rate of approximately 200-300 m³/hour. As will be appreciated, though, the rate at which the slurry is fed will depend on a variety of factors, including the size of the belt 12, the size of the apertures in the filter belt 12, and the quality/characteristics of the slurry itself. For example, a slurry having a lower percentage of solids will filter more rapidly than a slurry having a high percentage of solids. Similarly, a belt having apertures of 0.1 mm will filter more rapidly (have a higher capacity than) a belt having apertures of 0.06 mm. In certain embodiments a feed rate of 100 to 150 m³/hour may be appropriate.

As the slurry is conveyed along the conveyer belt, the jets or sprays 35 extending from the upper spray bars prevent the slurry from settling and create a turbulent flow in the slurry which ensures that there is free circulation of coal particles on the filter bed, which it maintains in a fluidized condition. In addition to promoting turbulent flow of the slurry and preventing stratification, the sprays 35 also assist in washing the ultra-fine particles from the surfaces of the larger particles and through the belt filter as filtrate. The filtrate accumulates in a sloped tray 37 which is angled to permit the free flow of filtrate to a discharge pipe 39 which discharges the filtrate to one side of the apparatus 10.

At the same time, the sprays 31 from the lower array of spray bars 30.1-30.5 clear the belt filter of any near-sized particles that may have become wedged or clogged in the apertures. The sprays 31 also serve to counter any stratification that may have occurred at the base of the filter bed and also assist in maintaining a slurry in a turbulent state as it travels along the belt filter. Each of the spray bars 30.1-30.5 and 28.1-28.5 is fitted with a regulating valve (not shown) to control both water flow and pressure in order to arm the belt filter. The pressure of the sprays 31 should be sufficient for the water to penetrate the filter cloth, for example by about 25 mm above the surface of the belt filter.

The spray bars are also fitted with a flush valve which, in the event that the sprays become clogged, can be opened to allow water to flow straight through the spray bars and flush/dislodge any material. The spray bars are fed from a single manifold arranged so that any combination of spray bars can be used to maximise their effect at minimal water consumption.

The sides of the upper reach 12A of the conveyer belt are angled upwardly as shown at 38 by means of elongate deflectors 40 extending inwardly from side portions of the frame. This enables the conveyer belt to accommodate a greater volume of slurry.

In order to promote further dislodging of near size particles from apertures in the belt filter, auxiliary spray bars 30.6 and 30.7 are configured to direct jets of water against the inner surface of a side reach of the conveyor belt 12. These auxiliary sprays assist in cleaning the belt on its return path to the discharge box 38.

As will be appreciated, the dimensions/positioning of the various components separation or belt filter apparatus 10 can be adapted to suit the desired purpose/throughput, and in accordance with the characteristics of the feed material.

By way of non-limiting example, the apparatus 10 may use a conveyor belt 12 having a width of between 1 to 3 meters, typically around 1.1 m. The belt 12 may have an upper reach 12A of between 4 to 6 meters long. As one example, the length of the upper reach 12 may be around 4.5 m and include 1 m of drainage, 1.5 m of travel above/beneath spray bars, and a further 2 m of drainage. The speed of the belt 12 will be varied to give maximum filtering efficiency for the instant feed material conditions. For example, for a slurry containing a low percentage of solids the belt can be operated at relatively high speeds, while a slurry with a high percentage of solids and a high proportion of finer material may require the belt to be operated at relatively low speeds. Typically, the apparatus 10 will be configured to provide for belt speeds of between approximately 500 m/hour to 1300 m/hour. In some embodiments a belt speed of 1000 m/hour will be suitable.

The number and spacing of the upper spray bars 28 and lower spray bars 30 will, again, depend on the application. Where fine material is being processed, a greater number of lower spray bars 30 may be warranted in order to clear the fine material from the apertures in the belt 12. Where coarser material is being processed, a greater number of upper spray bars 28 may be desired. In order to provide a reasonable coverage of the belt 12, a spacing of approximately 0.45 meters between spray bars may suffice, however alternate spacings could also be used.

The number and spacing of the apertures/nozzles on each spray bar are selected to as to provide complete coverage across the width of the belt 12. This number/spacing will depend on the type of aperture/nozzle, the direction of the apertures/nozzles, water pressure, and distance between the spray bar and the belt 12. In one embodiment: the upper spray bars 28.1-28.5 are positioned approximately 200 mm above the upper reach 12A of the belt; the lower spray bars 30.1-30.5 are positioned approximately 200 mm below the upper reach 12A of the belt; the apertures/nozzles on the top spray bars 28.1-28.5 are 90 degree sprays and are arranged to have an approximate spacing of 250 mm; the apertures/nozzles on the bottom spray bars 30.1-30.5 are 110 degree sprays and are arranged to have an approximate spacing of 300 mm; water is supplied to the upper and lower spray bars at approximately 2 litres/minute per spray bar at approximately 2 bar pressure.

The arrangement of overhead and lower sprays, in combination with the moving belt, resulted at least for the illustrated prototype an increase in throughput of coal fines by up to threefold to fivefold from 11 m³ per hour from a Baleen™ filter having a stationary screen and moving upper and lower spray arms to above 30 m³ per hour.

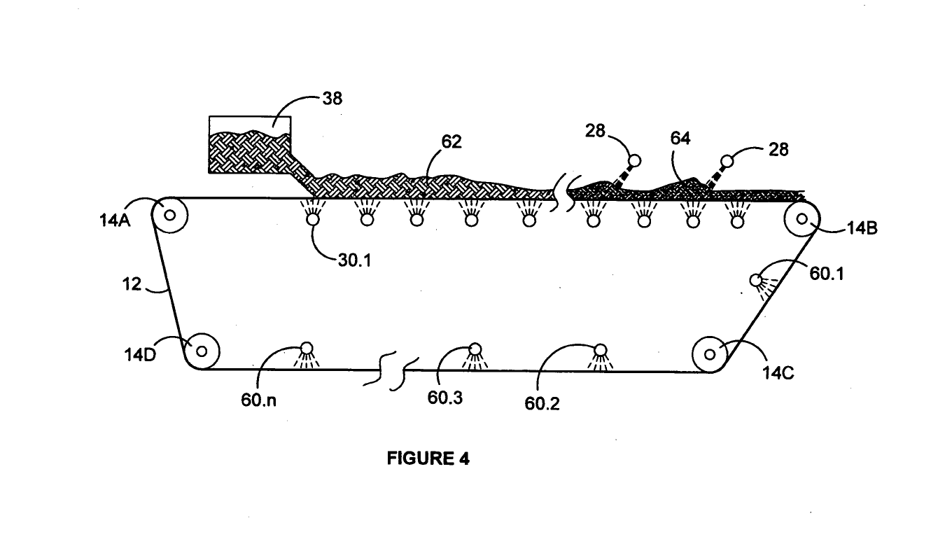

FIG. 4 is a schematic illustration of another configuration of the separation apparatus. In this arrangement there are two upper spray bars 28 that spray downward onto the material 62 lying on the belt 12. The upper spray bars are positioned towards the discharge end of the separation apparatus. The apparatus may be inclined so that the discharge end of the filter area is higher than the feed end. For example, the belt may be inclined by around 1 degree. The upper spray bars 28 may be set in order to form a ‘water dam’, for example dam 64, to hold the slurry for longer on the upper reach 12A of the filter belt.

In the illustrated arrangement there are more bottom spray bars (eg 30.1) than upper spray bars 28. Tests have indicated that the efficiency of the separation apparatus is dependent on the bottom spray bars. The bottom spray bars may be spaced at intervals of around 100 mm, although in some applications the spacing may be increased for the bottom spray bars closer to the discharge end. For example, the spacing may increase to 150 mm towards the discharge end.

The belt length plays an important role in the overall separation efficiency, provided the belt is not blinded. Thus, the number of bottom spray bars is increased if the belt length is increased. The water from the bottom spray bars penetrates the slurry 62, for example to around 25 mm about the surface of the belt 12. This removes near-sized particles from the pores of the belt and also agitates the slurry 62, thus aiding the removal of the finer material.

One or more auxiliary sprays 60.1 to 60.n are provided on the belt's return path to clean the pores of the belt. As illustrated, there is spray 60.1 cleans a side reach of the belt 12 and a plurality of sprays 60.2 to 60.n spray downwards to clear obstructions from the pores of the belt along its lower reach.

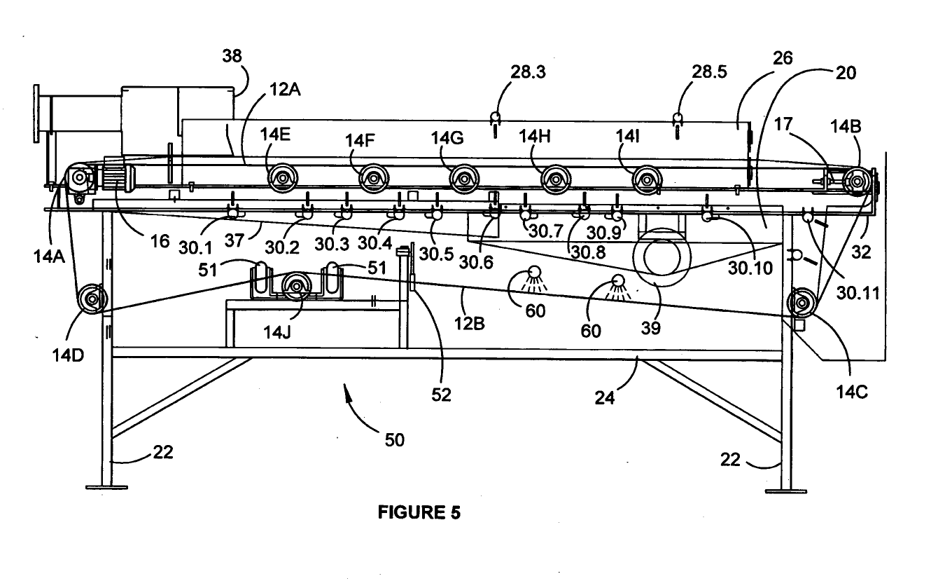

FIG. 5 shows another arrangement of the separation apparatus, which differs from the arrangement of FIG. 1 in that there are only two upper spray bars 28.3 and 28.5, but an increased number of bottom spray bars 30.1 to 30.10. The first bottom spray bar 30.1 is positioned beneath the outlet of the feed box 38. There are two bottom spray bars between adjacent rollers 14E-14I. For example, bottom spray bars 30.2 and 30.3 are positioned between rollers 14E and 14F.

There are two auxiliary spray bars, eg 30.11, cleaning a side reach the belt on its return path, and two auxiliary spray bars 60 cleaning the lower reach 12B of the belt, thus reducing cumulative blinding of the belt.

In one arrangement the length of the apparatus is around 6 m and the length from the discharge of feed box 38 to the discharge of the apparatus is around 5.5 m.

An example of source material that is suitable for processing by the separation apparatus described herein is a cyclone overflow stream from a classifying or de-sliming cyclone in a coal preparation system. The streams may, for example, have a solids content in the range of 4-10%.

In a series of tests the separation apparatus has been used to process material from a primary classifying cyclone overflow stream. Table 1 shows a size analysis of the material in this stream. The table describes a 13.0 kg sample with a % solids of 4.74.

TABLE 1
Size Analysis

| | | |
|---|---|---|
| Particle size | | |
| ranges (mm) | Fractional | Cumulative |

| − | + | Mass % | Ash % | Mass % | Ash % |
|---|---|---|---|---|---|
| | 0.250 | 0.50 | 6.7 | 0.50 | 6.7 |
| 0.250 | 0.125 | 3.93 | 5.1 | 4.43 | 5.3 |
| 0.125 | 0.090 | 4.25 | 5.2 | 8.68 | 5.2 |
| 0.090 | 0.063 | 4.30 | 8.3 | 12.98 | 6.3 |
| 0.063 | 0.038 | 7.51 | 13.3 | 20.50 | 8.8 |
| 0.038 | | 79.50 | 65.0 | 100.00 | 53.5 |

The left hand column lists the size ranges of the feed material in the sample. The separation apparatus described herein permits recovery of material in the size category >0.090 mm. It may be seen from the cumulative figures that this category includes 8.68% of the sample and furthermore the recoverable size category has an ash content of 5.2%. The recovered material thus has a relatively high grade.

An alternative technique of recovering material in this size fraction is to use froth flotation. However, it is considered that the separation apparatus described herein provides a simpler and cheaper means of recovering this useful material.

Tests on the cyclone overflow feed were run on a separation apparatus similar to that of FIG. 1, with five bottom spray bars. The apparatus used in the test is 4 m long, and the bottom spray bars are spaced along a drainage region between 2 to 2.5 m in length. The operating speed of the belt was around 1000 m/hr. Variations in belt speed affect the capacity of the unit and it was found that a belt speed of between 1000 and 1500 m/hr gave the greatest efficiency. The discharge end of the apparatus was raised by about 50 mm. If the belt speed is increased the discharge end may be further raised to reduce the potential for the slurry 62 to flow off the discharge end.

The tests showed a direct relationship between the bottom sprays and the capacity of the separation apparatus. For example, when one of the five bottom spray bars was switched off, the capacity of the unit in one trial fell from 37 m³/hr to 30 m³/hr. If the number of spray nozzles in use in the bottom spray bars was increased from 15 to 30, the capacity of the unit increased from 37 m³/hr to 58 m³/hr.

The aperture of the belt filter is selected in view of the size distribution of the feed material. In the example described above, the belt aperture is around 125 micron. This is obtained by weaving a belt from a 0.125 mm polyester fibre using a schedule 2 weave with a secondary fibre of 1 mm diameter woven through the material using a schedule 2 weave to provide additional strength. There are around 50-60 threads per cm of the 0.125 mm fibres per cm to provide the desired aperture size. This aperture size enables the recovery of material in the +0.090 mm class and the rejection of material less than 90 micron, which is predominantly clay. If the aperture size is reduced to around 75 micron, for example, there would be a greater proportion of the feed material liable to cause blinding of the filter. This may be counteracted by increasing the number of bottom spray bars and nozzles and/or the pressure of the water supply.

In general, the aperture size is chosen to recover desired material from the feed material. The relation of the aperture size to the size distribution of the feed material affects the likelihood of material blinding the filter. Thus, if a relatively fine mesh size is used (relative to the size distribution of the material) it may be necessary to increase the number of bottom spray bars and nozzles and/or the pressure of the water supply to avoid blinding of the filter.

It will be understood that the invention disclosed and defined in this specification extends to all alternative combinations of two or more of the individual features mentioned or evident from the text or drawings. All of these different combinations constitute various alternative aspects of the invention.

1. A separation conveyor for separating a mass or slurry of different sized particles, the separation conveyor including:
a filter belt including a feed side for receiving the mass or slurry and a filtrate side;
a conveyor assembly for conveying the filter belt;
an overhead spray array for spraying fluid downwards onto the slurry as it travels on the filter belt; and
a lower spray array for spraying fluid upwards against an underside of the belt,
wherein the upper and lower spray arrays are arranged in combination to assist in promoting separation of oversized particles on the feed side of the belt and undersized particles on the filtrate side of the belt.

2. The separation conveyor according to claim 1 in which the overhead spray array includes an array of overhead spray bars, and the lower spray array includes an array of lower spray bars, wherein the upper and lower spray bars are offset relative to one another.

3. The separation conveyor according to claim 1 in which the conveyor assembly includes a plurality of rollers around which the filter belt travels, the upper and lower spray arrays being arranged between the rollers.

4. The separation conveyor according to claim 1 in which the lower spray array includes at least one sidewardly or downwardly directed spray bar directed against an undersurface of the filter belt.

5. The separation conveyor according to claim 1 in which the filter belt is formed from a woven mesh having a mesh size of 40-250 μm.

6. The separation conveyor according to claim 5, wherein the woven mesh is selected from a group including steel mesh and fabric mesh.

7. The separation conveyor according to claim 1, wherein the conveyor assembly includes a variable speed motor providing for variable speed operation of the filter belt.

8. The separation conveyor according to claim 2, wherein each overhead spray bar is provided with a plurality of overhead sprays and each lower spray bar includes a plurality of lower sprays, and wherein the overhead sprays have a spray coverage that is different to a spray coverage of the lower sprays.

9. The separation conveyor according to claim 2, wherein the overhead spray array and lower spray array are plumbed to provide for independent operation of each overhead spray bar and each lower spray bar.

10. The separation conveyor according to claim 1 having a feed end at which the mass or slurry is received and a discharge end, wherein the lower spray array is distributed substantially between the feed end and the discharge end.

11. The separation conveyor according to claim 10 wherein the overhead spray array is positioned towards the discharge end.

12. The separation conveyor according to claim 10 wherein the discharge end is elevated relative to the feed end.

13. The separation conveyor according to claim 1 wherein fluid is sprayed from the lower spray array with sufficient pressure to penetrate a slurry on the feed side of the filter belt to a height of at least 20 mm above the filter belt.

14. A method of separating a slurry of different sized particles into undersize and oversize particles including:
feeding the slurry onto a filter belt having an upper feed side and a lower filtrate side;
driving the filter belt to convey the slurry;
directing sprays downwards onto the slurry via an overhead spray array;
directing sprays upwards against an underside of the filter belt via a lower spray array to unclog the filter belt of near-sized particles and to agitate the slurry, and
collecting the filtrate including the undersize particles and collecting the oversize particles at a downstream end of the filter belt.

15. The method according to claim 14 in which the undersize particles have a particle size range up to 40-50 μm, and the oversize particles have a particle size range above 40-50 μm.

16. The method according to claim 14, wherein the filter belt is driven at variable speeds depending on characteristics of the slurry.

17. The method according to claim 14 wherein the spray from the overhead spray array is directed to increase a retention time of the slurry on the filter belt.
